(19) United States
(12) Patent Application Publication
(10) Pub. No.: US 2014/0082498 A1
(43) Pub. Date: Mar. 20, 2014

(54) METHOD AND MOBILE TERMINAL DEVICE FOR INDEPENDENTLY PLAYING A VIDEO

(71) Applicant: TENCENT TECHNOLOGY (SHENZHEN) COMPANY LIMITED, Shenzhen (CN)

(72) Inventors: DING XIANG, Shenzhen (CN); YUEWEI FAN, Shenzhen (CN); MENG ZHOU, Shenzhen (CN)

(73) Assignee: TENCENT TECHNOLOGY (SHENZHEN) COMPANY LIMITED, Shenzhen (CN)

(21) Appl. No.: 14/085,751

(22) Filed: Nov. 20, 2013

Related U.S. Application Data
(63) Continuation of application No. PCT/CN2013/080479, filed on Jul. 31, 2013.

(30) Foreign Application Priority Data
Aug. 2, 2012 (CN) 201210272436.7

(51) Int. Cl. G06F 3/0484

(52) U.S. Cl. CPC G06F 3/0484
USPC 715/719

(57) ABSTRACT

Methods and mobile terminal devices for independently playing a video are disclosed. In an exemplary method, after receiving a command for independently playing a video that is triggered on a page window embedded with a video window, an independent video window that is independent from the page window can be created. A URL of a video source of a video to be played in the video window embedded in the page window can be obtained. The video source can be read and displayed in the independent video window.

### CROSS-REFERENCES TO RELATED APPLICATIONS

This is a continuation application of PCT Patent Application No. PCT/CN2013/080479, filed on Jul. 31, 2013, which claims priority to Chinese Patent Application No. 201210272436.7, filed on Aug. 2, 2012, the entire contents of all of which are incorporated herein by reference.

### FIELD OF THE DISCLOSURE

The present disclosure relates to the field of multimedia technology and, more particularly, relates to a method and a mobile terminal device for independently playing a video and even more particularly relates to a method and a large-screen mobile terminal device for independently playing a video.

### BACKGROUND

A mobile terminal device refers to a mobile computer device, which may broadly include mobile phones, notebook computers, tablet computers, POS (i.e., point-of-sale) devices, and even computers onboard vehicles. Examples of a large-screen mobile terminal device include tablet computers with large-screen high-definition resolution, for example, iPad, aPad, and Windows8, and large-screen smart phones.

Various browsers provided for conventional large-screen mobile terminal devices usually adopt a multi-tab technology, in which, when a new window is created, the window is directly displayed using a visible tab label and is arranged on an interface of a browser, as shown in FIG. 1. A user may directly perform operations with respect to a window, for example, selecting and closing the window. However, when a user is watching a video, the user is often unable to simultaneously perform other operations, for example, browsing a news web page. This is because, when switching to another tab, the video window is covered by content of the page of this switched tab, and thus the user cannot simultaneously watch the video and browse news. This greatly reduces degree of the use experience.

### BRIEF SUMMARY OF THE DISCLOSURE

According to various embodiments, there is provided a method for independently playing a video by first receiving a command for independently playing a video that is triggered on a page window embedded with a video window. An independent video window that is independent from the page window can be created. A URL of a video source of a video to be played in the video window embedded in the page window can be obtained. The video source can be read and displayed in the independent video window.

According to various embodiments, there is also provided a mobile terminal device. The mobile terminal device can include a receiving module, a creating module, an obtaining module, and displaying module. The receiving module can be configured to receive a command for independently playing a video that is triggered on a page window embedded with a video window. The creating module can be configured to create an independent video window that is independent from the page window. The obtaining module can be configured to obtain a URL of a video source of a video to be played in the video window that is embedded in the page window. The displaying module can be configured to read the video source and display the video source in the independent video window.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a conventional browser page on a mobile terminal device;

FIG. 2 depicts an exemplary method for independently playing a video in accordance with various disclosed embodiments;

FIG. 3 depicts another exemplary method for independently playing a video in accordance with various disclosed embodiments;

FIG. 4 depicts an exemplary page when calling and displaying a pop-up menu in accordance with various disclosed embodiments;

FIG. 5 depicts an exemplary page when creating an independent video window in accordance with various disclosed embodiments;

FIG. 6 depicts another exemplary method for independently playing a video in accordance with various disclosed embodiments.

FIG. 7 depicts an exemplary mobile terminal device in accordance with various disclosed embodiments;

FIG. 8 depicts another exemplary mobile terminal device in accordance with various disclosed embodiments;

FIG. 9 depicts another exemplary mobile terminal device in accordance with various disclosed embodiments;

FIG. 10 depicts an exemplary environment incorporating certain disclosed embodiments; and

FIG. 11 depicts an exemplary server consistent with the disclosed embodiments.

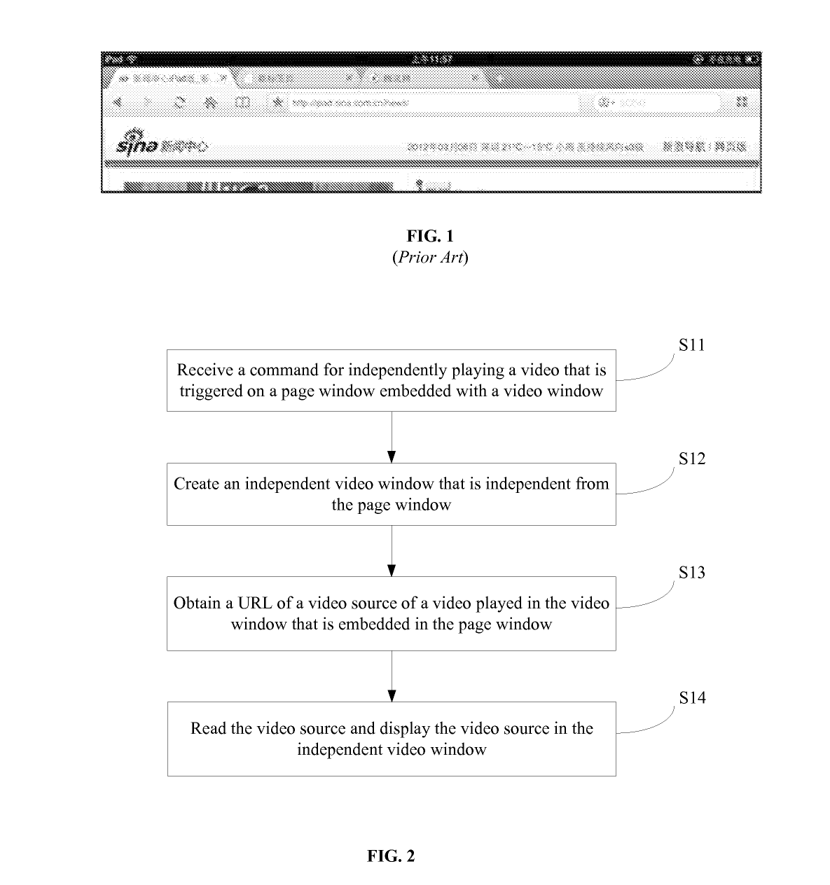

### DETAILED DESCRIPTION

Reference will now be made in detail to exemplary embodiments of the disclosure, which are illustrated in the accompanying drawings.

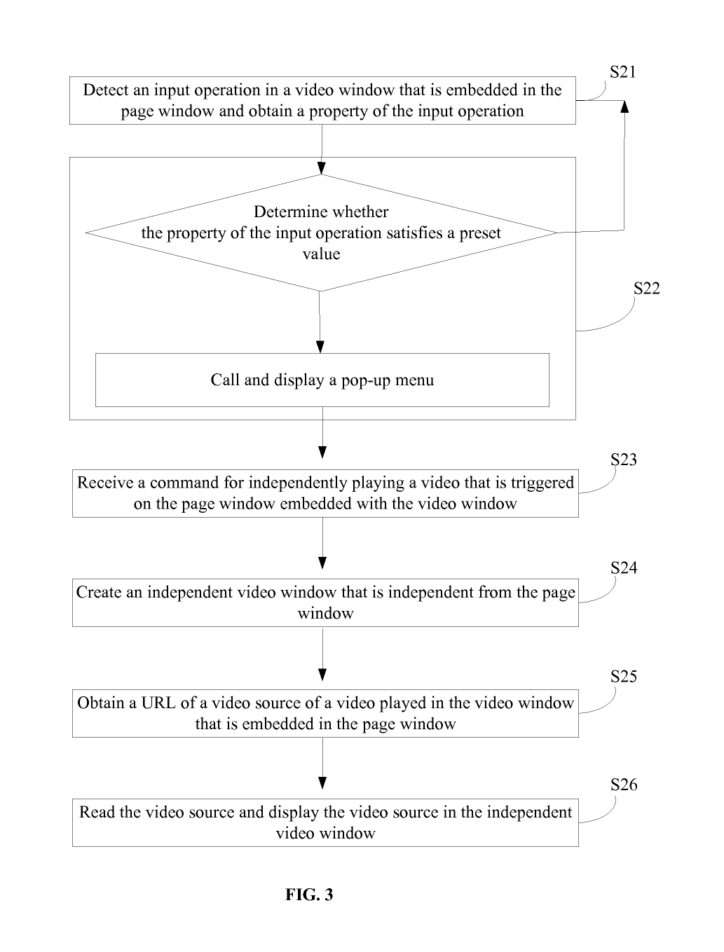

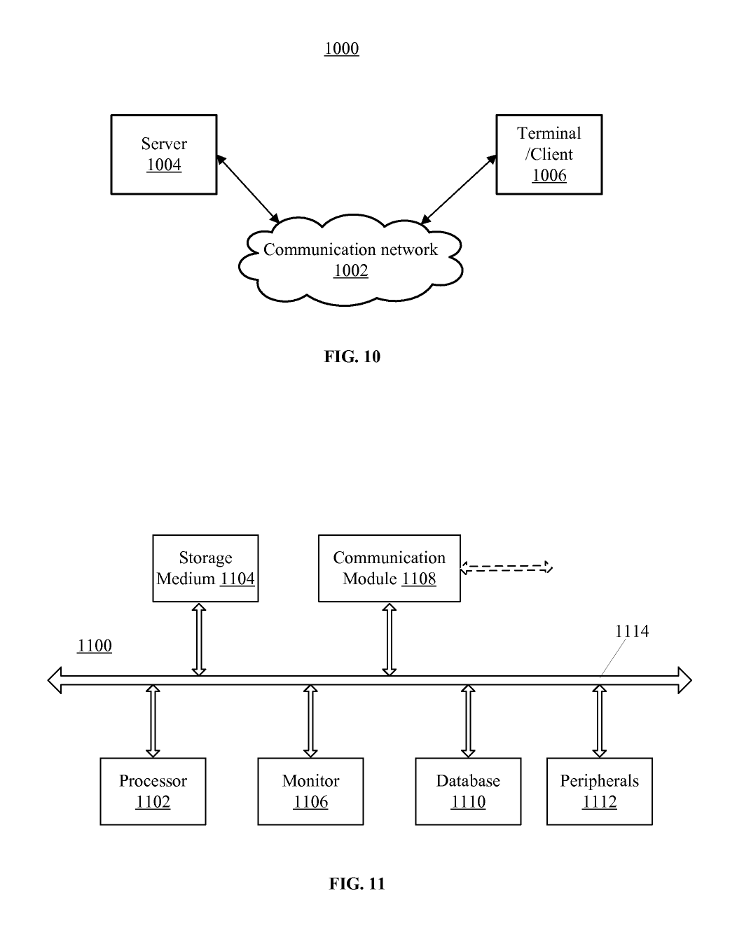

FIGS. 2-9 depict exemplary methods and mobile terminal devices for independently playing a video in accordance with various disclosed embodiments. The exemplary methods and devices can be implemented, for example, in an exemplary environment 1000 as shown in FIG. 10.

As shown in FIG. 10, the environment 1000 can include a server 1004, a terminal 1006, and a communication network 1002. The server 1004 and the terminal 1006 may be coupled through the communication network 1002 for information exchange, for example, Internet searching, webpage browsing, etc. Although only one terminal 1006 and one server 1004 are shown in the environment 1000, any number of terminals 1006 or servers 1004 may be included, and other devices may also be included.

The communication network 1002 may include any appropriate type of communication network for providing network connections to the server 1004 and terminal 1006 or among multiple servers 1004 or terminals 1006. For example, the communication network 1002 may include the Internet or other types of computer networks or telecommunication networks, either wired or wireless.

A terminal, as used herein, may refer to any appropriate user terminal with certain computing capabilities, for example, a personal computer (PC), a work station computer, a server computer, a hand-held computing device (tablet), a mobile terminal (a mobile phone or a smart phone), or any other user-side computing device.

A server, as used herein, may refer one or more server computers configured to provide certain server functionalities, for example, search engines and database management. A server may also include one or more processors to execute computer programs in parallel.

The server 1004 and the terminal 1006 may be implemented on any appropriate computing platform. FIG. 11 shows a block diagram of an exemplary computing system 1100 capable of implementing the server 1004 and/or the terminal 1006. As shown in FIG. 11, the exemplary computer system 1100 may include a processor 1102, a storage medium 1104, a monitor 1106, a communication module 1108, a database 1110, peripherals 1112, and one or more bus 1114 to couple the devices together. Certain devices may be omitted and other devices may be included.

The processor 1102 can include any appropriate processor or processors. Further, the processor 1102 can include multiple cores for multi-thread or parallel processing. The storage medium 1104 may include memory modules, for example, ROM, RAM, and flash memory modules, and mass storages, for example, CD-ROM, U-disk, removable hard disk, etc. The storage medium 1104 may store computer programs for implementing various processes, when executed by the processor 1102.

Further, the peripherals 1112 may include I/O devices, for example, keyboard and mouse, and the communication module 1108 may include network devices for establishing connections through the communication network 1002. The database 1110 may include one or more databases for storing certain data and for performing certain operations on the stored data, for example, webpage browsing, database searching, etc.

In operation, the terminal 1006 may cause the server 1004 to perform certain actions, for example, an Internet search or other database operations. The server 1004 may be configured to provide structures and functions for such actions and operations. More particularly, the server 1004 may include a data searching system for real-time database searching. In various embodiments, a terminal, for example, a mobile terminal involved in the disclosed methods and systems can include the terminal 1006.

On a large-screen mobile terminal, for example, iPad, iPhone, or aPad, when a URL of a video website is inputted using a browser, a backend of the video website identifies a type of the current browser based on a “user agent” parameter in a HTTP header and then provides specific video source accordingly. When mobile terminals, for example, iPad, iPhone, and aPad are used to visit a video website, the video website usually provides html5 video source. When a user opens a video window embedded in a page window of a first tab to watch a video and at the same time wishes to create a new page window of a new tab to browse a web page, the user can achieve this through the following embodiments.

FIG. 2 depicts an exemplary method for independently playing a video in accordance with various disclosed embodiments. An execution agent of the present exemplary embodiment can be a large-screen mobile terminal device, for example, a large-screen smart phone or a tablet computer, although other suitable mobile terminals can be encompassed herein without limitation.

In Step S11, a command for independently playing a video that is triggered on a page window is received. The page window can be embedded with a video window.

In Step S12, an independent video window that is independent from the page window is created.

Optionally, the step of creating an independent video window that is independent from the page window can further include steps of analyzing a size of the video window in the page window and creating the independent video window based on the size, the size of the independent video window being equal to the size of the video window in the page window. Optionally, after creating the independent video window of the page window, properties of the independent video window can be modified so that the independent video window can be displayed on top of all windows. Or the properties of the independent video window can be modified so that the independent video window can be freely dragged and size-adjustable.

In Step S13, a URL of a video source of a video to be played in the video window that is embedded in the page window is obtained.

In Step S14, the video source is read and displayed in the independent video window.

In the method provided by the present exemplary embodiment for independently playing a video, the independent video window that is independent from the original page window can be created and the video source in the original page window can be played in the independent video window. Thereby, the effect of simultaneously watching a video and browsing a web page can be achieved. This allows a user to watch a video while browsing other web pages and gives the user a better experience.

FIG. 3 depicts another exemplary method for independently playing a video in accordance with various disclosed embodiments. An execution agent of the present exemplary embodiment can be a large-screen mobile terminal device, for example, a large-screen smart phone, a tablet computer, or other suitable mobile terminal devices without limitation.

In Step S21, an input operation is detected in a video window embedded in a page window. A property of the input operation is obtained.

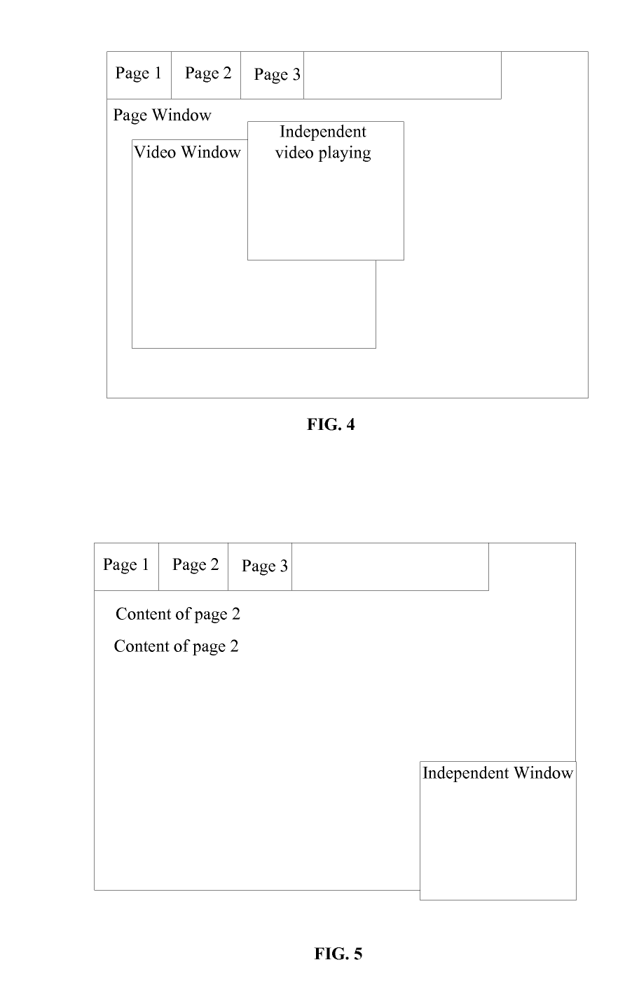

In Step S22, it is determined whether the property of the input operation satisfies a preset value. When the property of the input operation satisfies the preset value, a pop-up menu can be called and displayed. Referring to FIG. 4, the pop-up menu can include an option for independently playing a video that is for triggering a command for independently playing a video.

When the mobile terminal device being used uses a mouse as an input tool, the input operation can be pressing and holding a left button of the mouse or clicking a right button of the mouse. When a time period of pressing and holding the left button of the mouse satisfies the preset value or the right button of the mouse is clicked, the pop-up menu can be called and displayed. That is, the preset value can be a preset time period that the left button of the mouse is being pressed and held or can be that the right button of the mouse is clicked.

When the mobile terminal device being used uses a touch screen, the input operation can be a continued contact with the touch screen of the mobile terminal device, for example, having a time period that a finger or a stylus is in continued contact with the touch screen. When the time period of the continued contact satisfies the preset value, the pop-up menu can be called and displayed. In this case, the preset value can be a preset time period of a continued contact with the touch screen. When the property of the input operation does not satisfy the preset value, Step S21 can be repeatedly performed.

In Step S23, a command for independently playing a video that is triggered on the page window is received.

In Step S24, an independent video window that is independent from the page window is created.

Optionally, the step of creating an independent video window that is independent from the page window can further include steps of analyzing a size of the video window in the page window and creating the independent video window based on the size of the video window in the page window, the size of the independent video window being equal to the size of the video window in the page window.

Referring to FIG. 5, specifically, when a video is played in a video window of a browser according to html5, a browser kernel first resolves <video src=“videoUrl” width=“200” height=“200”></video>, and then creates an independent area of 200×200 (height by width) for playing the video and, at the same time, reads data source specified by “videoUrl” via operating system itself or via a video decoding technology or a plug-in that comes with the browser to realize the video playing. The independent video window is not limited to a window managed by the browser itself, but may also be created and managed by the kernel.

Optionally, after creating the independent video window of the page window, properties of the independent video window can be modified so that the independent video window can be displayed on top of all windows. Or the properties of the independent video window can be modified so that the independent video window can be freely dragged and be size-adjustable.

In Step S25, a URL of a video source of a video to be played in the video window is obtained. The video window can be embedded in the page window.

In Step S26, the video source is read and displayed in the independent video window.

In the method provided by present exemplary embodiment for independently playing a video, the independent video window that is independent from the original page window can be created and the video source in the original page window can be played in the independent video window. Thereby, the effect of simultaneously watching a video and browsing a web page can be achieved. This allows a user to watch a video while browsing other web pages, and gives the user a better experience.

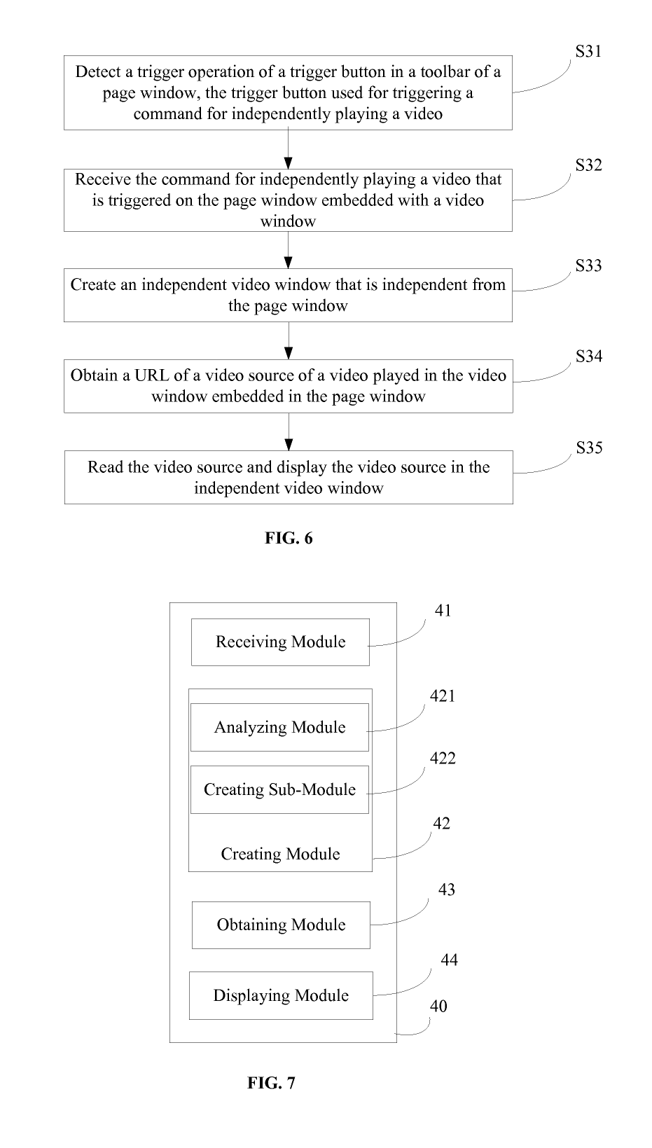

FIG. 6 depicts another exemplary method for independently playing a video in accordance with various disclosed embodiments. An execution agent of the present exemplary embodiment can be a large-screen mobile terminal device, for example, a large-screen smart phone, a tablet computer, or other suitable mobile terminal devices without limitation.

In Step S31, a trigger operation of a trigger button in a toolbar of a page window is detected. The trigger button can be used for triggering a command for independently playing a video.

In Step S32, the command for independently playing a video that is triggered on the page window is received. The page window can be embedded with a video window.

In Step S33, Create an independent video window that is independent from the page window.

Optionally, the step of creating an independent video window that is independent from the page window can further include steps of analyzing a size of the video window in the page window and creating the independent video window based on the size of the video window in the page window, the size of the independent video window being equal to the size of the video window in the page window. Optionally, after creating the independent video window of the page window, properties of the independent video window can be modified so that the independent video window can be displayed on top of all windows. Or the properties of the independent video window can be modified so that the independent video window can be freely dragged and be size-adjustable.

In Step S34, a URL of a video source of a video to be played in the video window is obtained. The video window can be embedded in the page window.

In Step S35, the video source is read and displayed in the independent video window.

In the method provided by the present exemplary embodiment for independently playing a video, the independent video window that is independent from the original page window can be created and the video source in the original page window can be played in the independent video window. Thereby, the effect of simultaneously watching a video and browsing a web page can be achieved. This allows a user to watch a video while browsing other web pages and gives the user a better experience.

FIG. 7 depicts an exemplary mobile terminal device in accordance with various disclosed embodiments. The exemplary mobile terminal device can be a large-screen mobile terminal device, for example, a large-screen smart phone, a tablet computer, or other suitable mobile terminal device without limitation.

The exemplary mobile terminal device can include a receiving module 41, a creating module 42, an obtaining module 43, and/or a displaying module 44.

The receiving module 41 can be used to receive a command for independently playing a video that is triggered on a page window that is embedded with a video window. The creating module 42 can be used to create an independent video window that is independent from the page window. Optionally, the creating module 42 can include an analyzing module 421 for analyzing a size of the video window in the page window, and a creating sub-module 422 for creating the independent video window based on the size of the video window in the page window, a size of the independent video window being equal to the size of the video window in the page window.

Optionally, the creating module 42 can further include a property modifying module 423 for modifying a property of the independent video window, for example, modifying a property of the independent video window so that the independent video window can be displayed on top of all windows or modifying a property of the independent video window so that the independent video window can be freely dragged and be size-adjustable. The obtaining module 43 can be used to create the independent video window that is independent from the page window. The displaying module 44 can be used to read a video source and display the video source in the independent video window.

In the mobile terminal device provided by the present exemplary embodiment, the independent video window that is independent from the original page window can be created and the video source in the original page window can be played in the independent video window. Thereby, the effect of simultaneously watching a video and browsing a web page can be achieved. This allows a user to watch a video while browsing other web pages and gives the user a better experience.

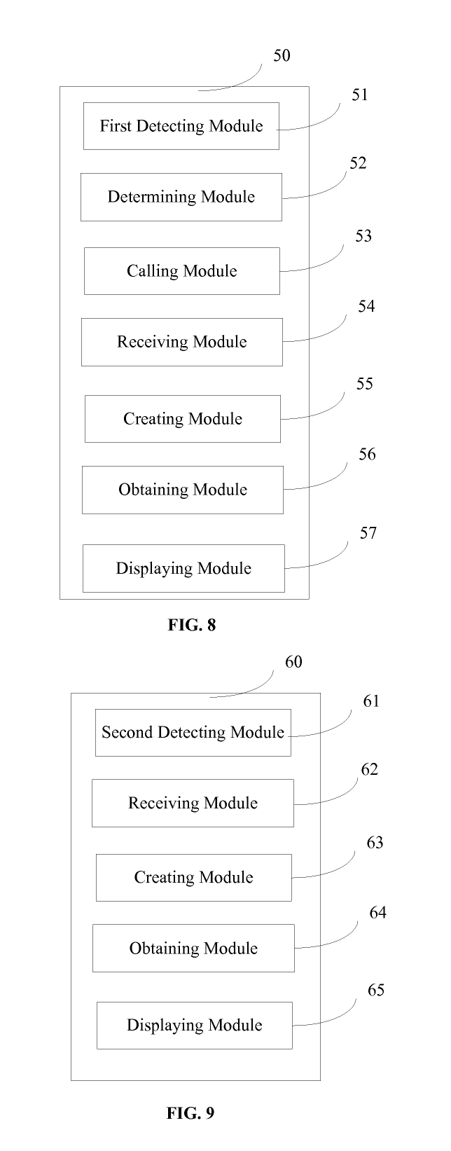

FIG. 8 depicts another exemplary mobile terminal device in accordance with various disclosed embodiments. The exemplary mobile terminal device can be a large-screen mobile terminal device, for example, a large-screen smart phone, a tablet computer, or other suitable mobile terminal device without limitation.

The exemplary mobile terminal device can include a first detecting module 51, a determining module 52, a calling module 53, a receiving module 54, a creating module 55, an obtaining module 56, and/or a displaying module 57.

The first detect module 51 can be used to detect a property of an input operation in a video window that is embedded in a page window and obtain a property of the input operation. The determining module 52 can be used to determine whether the property of the input operation satisfies a preset value. The calling module 53 can be used to call and display a pop-up menu when the determining module 52 determines that the property of the input operation satisfies the preset value, the pop-up menu containing an option for independently playing a video that can be used to trigger a command for independently playing a video.

The receiving module 54 can be used to receive the command for independently playing a video that is triggered on the page window embedded with the video window. The creating module 55 can be used to create an independent video window that is independent from the page window. The obtaining module 56 can be used to obtain a URL of a video source of a video being played in the video window that is embedded in the page window. The displaying module 57 can be used to read a video source and display the video source in the independent video window.

In the mobile terminal device provided by the present exemplary embodiment, the independent video window that is independent from the original page window can be created and the video source in the original page window can be played in the independent video window. Thereby, the effect of simultaneously watching a video and browsing a web page can be achieved. This allows a user to watch a video while browsing other web pages and gives the user a better experience.

FIG. 9 depicts another exemplary mobile terminal device in accordance with various disclosed embodiments. The exemplary mobile terminal device can be a large-screen mobile terminal device, for example, a large-screen smart phone, a tablet computer, or other suitable mobile terminal device without limitation.

The exemplary mobile terminal device can include a second detecting module 61, a receiving module 62, a creating module 63, an obtaining module 64, and/or a displaying module 65.

The second detecting module 61 can be used to detect a trigger operation of a trigger button in a toolbar of a page window. The trigger button can be used for triggering a command for independently playing a video. The receiving module 62 can be used to receive the command for independently playing a video that is triggered on the page window embedded with a video window.

The creating module 63 can be used to create an independent video window that is independent from the page window. The obtaining module 64 can be used to obtain a URL of a video source of a video being played in the video window that is embedded in the page window. The displaying module 65 can be used to read a video source and display the video source in the independent video window.

In the mobile terminal device provided by the present exemplary embodiment, the independent video window that is independent from the original page window can be created and the video source in the original page window can be played in the independent video window. Thereby, the effect of simultaneously watching a video and browsing a web page can be achieved. This allows a user to watch a video while browsing other web pages and gives the user a better experience.

It should be noted that all disclosed embodiments are described in a progressive manner and in a manner that differences between various embodiments are mainly described. Descriptions for same or similar parts among the embodiments can be mutually referenced. The device embodiments are substantially similar to the method embodiments, and for similar parts, and reference can be made to descriptions of corresponding parts in the method embodiments.

It should be noted that, in the present specification, relationship terms, for example, “first” and “second” are only used to distinguish one entity or operation from another entity or operation, but do not necessarily require or imply that there actually exists any such relationship or sequential order between these entities or operations. Further, the terms “comprise,” “include” or other variations thereof are intended to cover non-exclusive inclusion so that a process, method, article or device that includes a series of elements does not only include these elements but also includes other elements that are not explicitly listed or also includes intrinsic elements of the process, method, article or device. In case where there is no more limitation, an element limited by a sentence “including one” does not exclude presence of another identical element in a process, method, article or device that includes the element.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

The disclosed embodiments can be examples only. One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a storage medium. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the disclosed methods and mobile terminal devices for independently playing a video, an independent video window that is independent from an original page window can be created and a video source in the original page window can be played in the independent video window. Thereby, the effect of simultaneously watching a video and browsing a web page can be achieved. This allows a user to watch a video while browsing other web pages on a mobile terminal device and gives the user a better experience.

What is claimed is:

1. A method for independently playing a video, comprising:
receiving a command for independently playing a video that is triggered on a page window, wherein the page window is embedded with a video window;
creating an independent video window that is independent from the page window;
obtaining a URL of a video source of a video to be played in the video window embedded in the page window; and
reading the video source and displaying the video source in the independent video window.

2. The method of claim 1, wherein before the step of receiving the command for independently playing a video, the method further comprises:
detecting an input operation in the video window that is embedded in the page window and obtaining a property of the input operation;
determining whether the property of the input operation satisfies a preset value, and
calling and displaying a pop-up menu when it is determined that the property of the input operation satisfies the preset value, the pop-up menu containing an option for independently playing the video used for triggering the command for independently playing the video.

3. The method of claim 2, wherein the input operation comprises pressing and holding a left button of a mouse or clicking a right button of the mouse.

4. The method of claim 2, wherein the input operation comprises a continued contact with a screen of a mobile terminal device.

5. The method of claim 1, wherein before the step of receiving the command for independently playing the video, the method further comprises detecting a trigger operation of a trigger button in a toolbar in the page window, the trigger button used for triggering the command for independently playing the video.

6. The method of claim 1, wherein the step of creating the independent video window that is independent from the page window comprises:
analyzing a size of the video window in the page window; and
creating the independent video window based on the size of the video window in the page window, wherein a size of the independent video window equals to the size of the video window in the page window.

7. The method of claim 6, wherein the step of creating the independent video window that is independent from the page window further comprises:
modifying a property of the independent video window such that the independent video window is displayed on top of all windows.

8. The method of claim 6, wherein the step of creating the independent video window that is independent from the page window further comprises:
modifying a property of the independent video window such that the independent video window is freely dragged and size-adjustable.

9. A mobile terminal device comprising:
a receiving module, configured to receive a command for independently playing a video that is triggered on a page window, wherein the page window is embedded with a video window;
a creating module, configured to create an independent video window that is independent from the page window;
an obtaining module, configured to obtain a URL of a video source of a video to be played in the video window that is embedded in the page window; and
a displaying module, configured to read the video source and display the video source in the independent video window.

10. The device of claim 9, further comprising:
a first detecting module, configured to detect an input operation in the video window that is embedded in the page window and to obtain a property of the input operation;
a determining module, configured to determine whether the property of the input operation satisfies a preset value; and
a calling module, configured to call and display a pop-up menu when the determining module determines that the property of the input operation satisfies the preset value, the pop-up menu containing an option for independently playing the video used for triggering the command for independently playing the video.

11. The device of claim 9, further comprising:
a second detecting module, configured to detect a trigger operation of a trigger button in a toolbar of the page window, wherein the trigger button is configured to trigger the command for independently playing the video.

12. The device of claim 9, wherein the creating module comprises:
an analyzing module, configured to analyze a size of the video window in the page window; and
a creating sub-module, configured to create the independent video window based on the size of the video window in the page window, wherein a size of the independent video window equals to the size of the video window in the page window.

13. The device of claim 12, wherein the creating module further comprises:
a property modifying module, configured to modify a property of the independent video window such that the independent video window is freely dragged and size-adjustable on the mobile terminal device.

14. The device of claim 10, wherein the input operation comprises pressing and holding a left button of a mouse or clicking a right button of the mouse.

15. The device of claim 10, wherein the input operation comprises a continued contact with a screen of a mobile terminal device.

16. The device of claim 12, wherein the creating module further comprises:
a property modifying module, configured to modify a property of the independent video window such that the independent video window is displayed on top of all windows mobile terminal device.
